(19) United States
(12) Patent Application Publication
(10) Pub. No.: US 2007/0126867 A1
(43) Pub. Date: Jun. 7, 2007

(54) High resolution surveillance camera

(76) Inventor: David McCutchen, Portland, OR (US)

Correspondence Address: IPSOLON LLP, 111 SW COLUMBIA, SUITE 710, PORTLAND, OR, 97201, US

(21) Appl. No.: 11/293,409

(22) Filed: Dec. 2, 2005

(51) Int. Cl. H04N 7/18

(52) U.S. Cl. 348/143

(57) ABSTRACT

A surveillance device makes use of a fixed point in space such as a stabilized blimp, and a downward-looking high-resolution scanning camera. One or more line scan devices are arranged in a radial fashion on a rotating disk, together with associated lenses, so as to repeatedly scan an area of interest. To allow for manageable data bandwidth and to focus on objects of interest, the data from successive scans is compared so as to show primarily the moving objects, with occasional full-scan reference images included.

### FIELD OF THE INVENTION

This invention generally relates to digital imaging systems, and in particular to such a system that employs rotary line scanning and reduction of non-essential image elements to provide a high-resolution surveillance system.

### BACKGROUND AND SUMMARY OF THE INVENTION

In chaotic situations it is difficult to know what to photograph. It is easy to miss an essential element. If a crime has been committed, it is even more important to gather crucial evidence. But too often the meaning of images can only be appreciated later. Therefore the best forensic analysis would allow one to see a total picture of the essential elements and also be able to trace the most important ones after the fact. In combating an insurgency in an urban area, for example, it would be desirable to continuously image all of an area over which insurgency events might occur, so as to have the ability to trace back from such an event any movements or actions that led up to it. Conventional imaging systems and technologies are incapable of providing such imagery because they lack the ability to persistently image such large areas and the ability to process the vast amounts of image data that would arise from such imagery. It will be appreciated that this example illustrates only one application of such a capability, which would have much wider applicability.

In some urban settings large numbers of standard closed-circuit television cameras each record a two-dimensional view of a scene. Although some of the recorded scenes might be overlapping or contiguous, the scenes are generally selected strategically to capture only areas of highest activity or risk, leaving gaps between the scenes that are being imaged. The reason is that the numbers of cameras and images that would be required to capture all of an urban core, for example, would be prohibitive. As a consequence, events that occur in the gaps between camera scenes are not recorded. The various camera images are scattered, and not able to be presented as a unified picture. In addition, retrieval of relevant images after an event is generally done manually by an operator or investigator reviewing tapes of the recorded scenes.

Accordingly, the present invention provides a high-resolution surveillance camera system capable of persistently imaging a large-scale surveillance area. In operation, the surveillance camera is supported by a raised platform to form a generally downward view of the area. The camera includes at least one line scan sensor and a rotational drive system to provide rotational imaging with the line scan sensor to obtain raw image data of the surveillance area. In one implementation, a processor reduces the raw image data to motion image data that corresponds to changes between successive frames.

Line scan devices offer high resolution in building up a photographic image, but have been previously used in certain applications. They have been primarily applied to straight, linear image scans such as, for example, machine vision imaging in which images of moving objects on conveyor belts are captured, or satellite imaging in which a terrestrial image is scanned by orbital motion of the satellite. In another use, line scan devices are aligned parallel with and rotated about an axis of rotation to form scanning a panoramic still image.

In contrast, the at least one line scan sensor in a camera of the present invention is arranged to be not parallel to the axis of rotation. For example, the at least one line scan sensor may be perpendicular to, or at an acute angle to, the axis of rotation. As a result, the rotation of the line scan sensor allows high-resolution multi-frame (e.g., motion) images to be formed for a much larger image area than conventional closed circuit television cameras.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 illustrates a high-resolution persistent surveillance system according the present invention.

FIG. 2 is a diagrammatic illustration of rotational line scan imaging.

FIG. 3 is a diagrammatic block and side view of a camera system according the present invention.

FIG. 4 is a diagrammatic illustration of an alternative line scan sensor arrangement employing plural line scan sensors.

FIG. 5 is a diagrammatic illustration of multiple line scan sensors arranged in concentric rings.

FIG. 6 is a diagrammatic side view of an alternate arrangement with a tower support.

FIG. 7 is a diagrammatic side view of multiple line scan sensors and their associated lenses and optical axes.

### DETAILED DESCRIPTION OF PREFERRED EMBODIMENTS

In the discussion that follows, terms such as “persistent surveillance system” to refer to sample implementations of the present invention. However, no particular limitation should be inferred in the scope or applicability of the invention from use of this term.

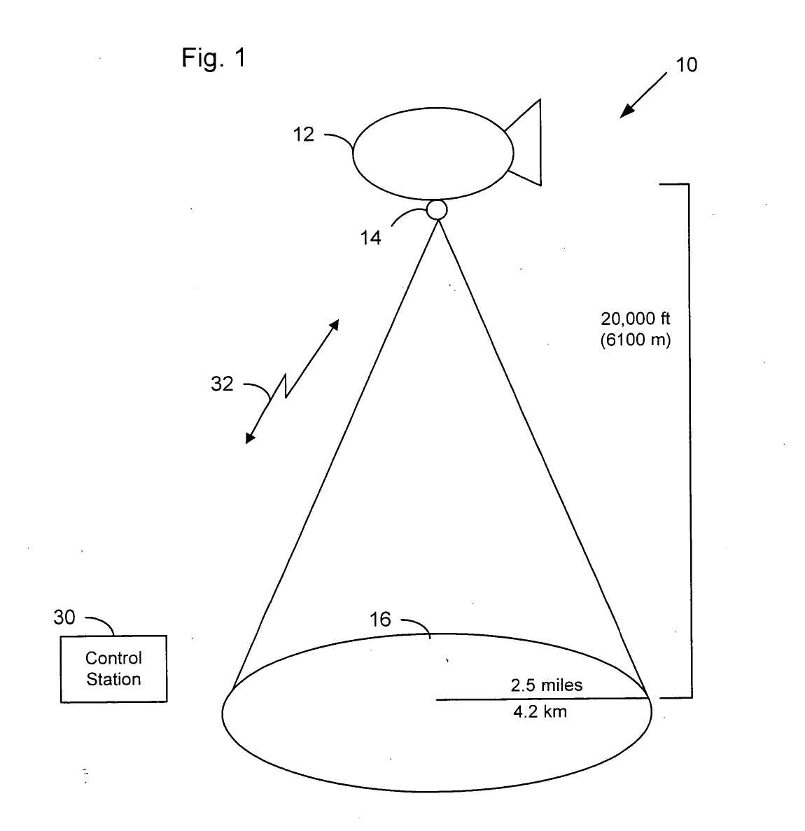

The present invention features a repeated high-resolution scanning of a wide area from a fixed position. FIG. 1 illustrates a high-resolution persistent surveillance system of a wide area 10 according the present invention. The persistent surveillance system 10 includes a persistent airborne platform such as a stabilized aerostat, blimp, dirigible or tethered balloon, referred to as a blimp 12, which supports a downward-looking high resolution surveillance camera system 14.

This high resolution camera system 14 continuously images a large surveillance area 16 of multiple square miles at a resolution capable of discerning vehicles and individual human beings. In one example implementation, surveillance area 16 corresponds to a circle with a radius 18 of about 2.5 miles (13,200 feet) and encompasses an area of about 20 square miles, and the blimp 12 maintains camera system 14 at a relative elevation of about 20,000 feet.

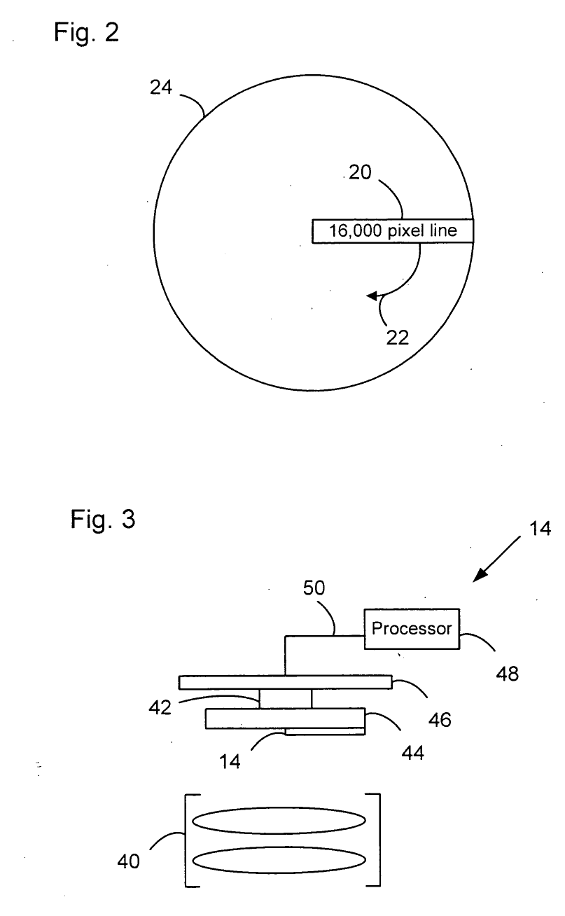

FIG. 2 is a diagrammatic illustration of the operation of the image scanning of camera system 14 (FIG. 1). In one implementation, camera 14 includes a line scan sensor 20 with, for example, a color resolution of 16,000 pixels. The line scan sensor 20 may be a single monolithic sensor or may be formed from plural separate line scan sensor elements. Line scan sensor 20 is swept in a circular scan 22 to form a field of view 24 of surveillance area 16 of about 803,840,000 (π*16,000²) pixels per complete rotation. This represents a ground sample distance of 1 square foot per pixel, which represents a NIIRS (National Imagery Interpretability Rating Scale) resolution of about 6, easily enough to see cars and even the shadows of individuals. One or more line scan sensors can perform this rotation within the lens image formed by a single fixed lens, or each sensor can have its own lens, moving together as a unit, as described below in greater detail.

With reference to FIG. 1, an image signal is transmitted from camera system 14 to a control station 30 (e.g., a ground station) over a high capacity digital signal link 32. As a result, camera system 14 and control station 30 include appropriate transceivers, antennae, etc. In operation, control station 30 may also transmit camera system control signals and other system control signals to camera system 14. For example, a Data Translation Camera Link (33 MHz 32 bit) frame grabber for up to 16K line scan sensor has a maximum transfer rate of 132 MB/sec, equal to a 16K sensor at 8250 scans/sec. At frame rates of 10 fps, 20 fps, or 30 fps, the full raw image data of 1608 MB per frame (804 Mpixels with at least 2 bytes per pixel) would be difficult to transmit.

It will be appreciated, however, that the transmission of all of the raw image data is not necessary for persistent surveillance. What is most desired in this application are images of moving elements, such as people and cars, not the static elements like trees and buildings. Therefore, in one implementation, the raw image data from each sweep (i.e., from each frame) is subtracted from the immediately preceding frame, thereby providing a movement image signal that includes only the moving or changing objects with a reference to where they are located in the image frame, while the non-moving objects are essentially reduced to zero. The movement image signal is then transmitted over link 32 to control station 30 or stored locally for later transmission.

The movement image signal would still lead to a high bandwidth overall, but if the raw image data can be reduced by a factor of 100:1, then the 1608 MB frame image becomes 16 MB. This represents a reduced number of pixels, on an essentially black background, which can then be further compressed by conventional codecs to form the final transmitted image data. Existing codecs such as the MPEG family, especially the H.264/MPEG-4 standard, already employ data reduction through detecting and encoding the moving parts of an image. The bandwidth can be further reduced, and the objects of interest can be further identified, if they are run through object-recognition and tracking software to isolate and identify them, even if they are part of a large and complex moving pattern.

Therefore, with data reduction and compression, even at a frame rate of several frames per second, the image data can be captured with a high-bandwidth data recorder such as the Dodeca 2000/2360 Telemmersion® Camera System, available from Immersive Media Company of Portland, Oreg. which is capable of recording 110 million pixels per second, compressed to a write speed of 24 MB/sec. As an alternate form of image data recorder, even a conventional DVCPRO HD video tape recorder (e.g., the AJ-1200a available from Panasonic) can be employed. Other forms of data recorders are also available. An ideal recording system would be able to record for long periods of time in a secure manner, and be easily searchable for any desired information. The target frame rate for successive for sweeps of the overall image should be at least 1 fps, but preferably 10 fps, 20 fps or 30 fps for better recording of motion.

Using the described invention with an event such as a bombing, the image recording can be traced back in time prior to the event. Given that the time and place of the crime (e.g., the bombing) is known, the perpetrators can be seen planting it, and they can be traced back to where they came from. Other traffic patterns will reveal the extent of their associates.

FIG. 3 is a diagrammatic block and side view of a camera system 14, which includes line scan sensor 14, a high quality, aerial surveillance grade lens arrangement 40, a motor drive 42 to provide rotational sweep of line scan sensor 14 on a rotational scan wheel 44 relative to a fixed hub 46, and a localized processor 48 that is coupled to line scan sensor 14 by a high bandwidth data bus 50. Scan wheel 44 has or defines a major plane that rotates about a rotational axis and is substantially parallel to the surveillance area. Lens arrangement 40 is of a high aerial surveillance optical quality to minimize resolution losses in the lens arrangement and to be as sensitive to light as possible so that imaging can be done in different lighting conditions. Processor 48 provides onboard data analysis and reduction to obtain the motion image data.

An occasional image scan cycle can be devoted to a non-reduced, full-resolution image that can serve as an optional background or context image. Such an image can also provide a double-check against missing information and can assist in adapting the system to changing lighting and weather conditions. Accordingly, a complete raw image may be transmitted to control station 30 periodically (e.g., once every selected number of seconds or minutes). Processor 48 may optionally provide electronic image stabilization with reference to landmarks within the image, such as streetlights or other still targets, to keep the overall image as stable as possible to minimize erroneous indications of moving object artifacts.

Detected offsets in position that appear as dramatic increases on the frame-to-frame motion of the objects in the frame can be sent to the navigation and stabilization system of the blimp to aid it in maintaining its position. In addition, camera system 14 may include mechanical stabilization, such as one or more gyroscopes, to increase image stability.

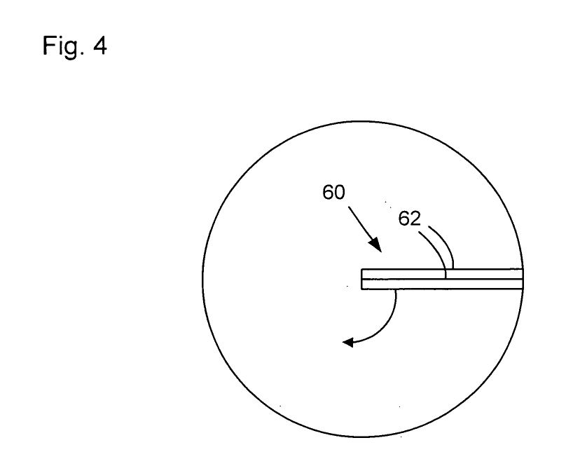

FIG. 4 is a diagrammatic illustration of an alternative line scan sensor arrangement 60 employing plural line scan sensors 62. FIG. 4 shows only two line scan sensors 62, but more than that number could be used. In one implementation, each of the plural line scan sensors 62 may be for the same type of imaging or light (e.g., visible light) to be used cooperatively to build up resolution faster. The line scan sensor may be CCD, CMOS or any other type as required for best performance. Line scan sensors tend to be insensitive to light because their constant motion prevents them from lingering over a given image target to increase the amount of light captured. Plural sensors 62 placed close together in parallel can act to increase the effective light-gathering capacity of the individual pixels by repeated imaging of the same spot with successive sensors 62. The results of each of the plural sensors 62 can then be summed together to obtain increased image signal resolution. Also, the scanning speed can be adjusted to the lighting conditions, with slower scans for low light conditions (e.g., at night) and faster scans in bright conditions (e.g., daytime). The

In alternative implementations, the plural line scan sensors 62 may be directed to different types of imaging or light. For example, one or more line scan sensors 62 could image visible light while one or more other line scan sensors 62 could be adapted for one or more of LIDAR, infrared, etc. Also, conventional area (i.e., two-dimensional) sensors can be used to provide reference images and could be placed in the non-moving hub 46.

The essential moving objects, isolated on an essentially blank field, can be identified by color, shape and other factors, and reduced further to symbols or icons moving on the blank field. These symbols can be transmitted with low-bandwidth connections to portable devices such as cell phones or other mobile user devices.

During the scan there is a varying density of pixels, because the interior is scanned more often than the outside edge. For a scanned image disk with a radius of 16,000 pixels, a basic density might be determined at a midway point. The density therefore along a circumference line halfway out onto the radius equals 50,265 pixels around, and since each scan of the line sensor would produce one of these pixels, this equals 50,265 scans. If one is using the Camera Link interface, the maximum bandwidth of 132 MB/s means that for a 16K imager there could be 8250 scans per sec (at 1 byte per pixel), so 6 sensors would nearly cover the whole amount in 1 second, using every pixel. To maintain the same data density, one can safely discard samples more and more as one travels toward the center, while the data will be progressively thinner unless it is augmented from another source, such as additional sensor scans or a simulation via interpolation from the existing data.

A small variation of the length of the scans, accomplished by increasing the clock rate but discarding image information before it is sent out on the camera bus, can safely preserve the essential information and increase the effective scan rate. For example, if every other scan were made to be 15,000 pixels instead of 16,000 pixels long, by beginning the scan at a point farther from the center, the missing information can be easily found from the adjacent scans in this densely scanned center area, and the overall scan rate, and the overall scan rate is increased to 8516 scans per second, which is more than enough to cover the number of pixels around the 50% circumference with six sensors.

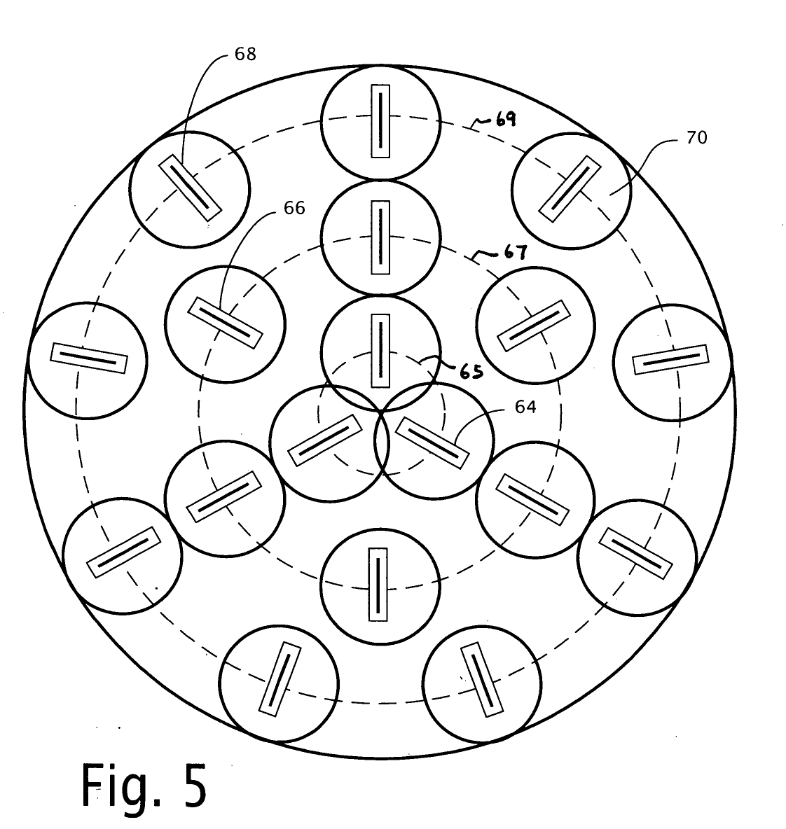

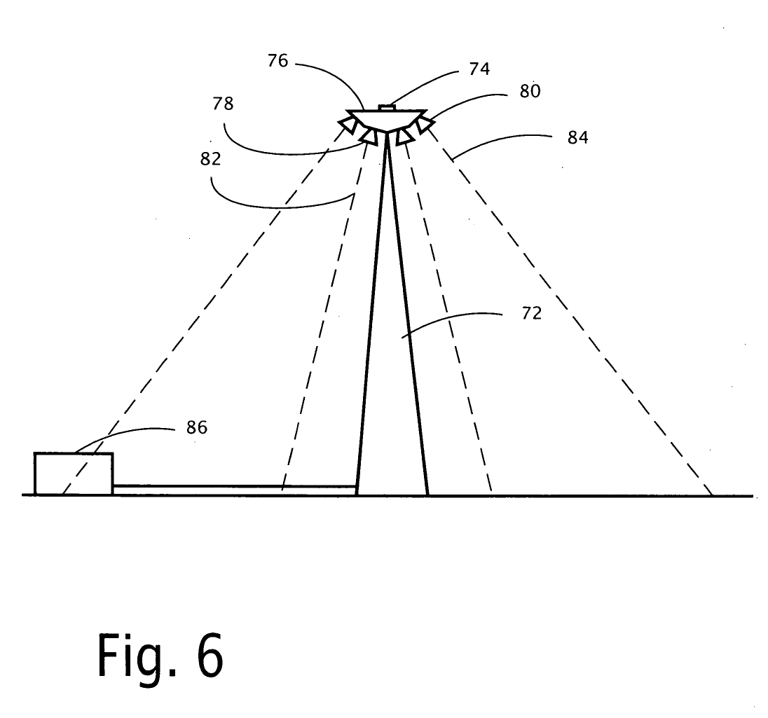

To produce an optimal balance of density of the scanned image between the inner diameter and the outer diameter, multiple sensors with shorter line lengths can be employed in concentric rings. One optimal arrangement of sensors employs sensors arranged in three concentric rings, as shown in FIG. 5. An innermost ring 65 at an inner radius has three sensors such as at 64, a middle ring 67 at a middle radius has six sensors, such as at 66, and an outer ring 69 at an outer radius has nine sensors, such as at 68. The line sensors themselves are shown, together with the limits of the image, for example at 70, produced by their associated lenses. If the lenses have a wider field of view, there will be more overlap between the concentric rings. In the example above, the circumference of the image at a distance 25% out from the center is 25,132 pixels, which can be covered by three sensors each producing at least 8500 scans. For the circumference of 50,265 pixels at a distance 50% out, six sensors would be required, and for the outer ring at a diameter 75% out, nine sensors would be needed to cover the distance of 75,398 pixels. For best results, the rings should overlap, to aid the blending of the overall image, and fill in the attenuated sections of the outside of a ring with the denser portions at the inside of the next ring. So for the above example, 6K line sensors can produce a required 16K overall radius for the overall image, with a 1K pixel overlap for blending between each ring, and also for helping to interpolate the center and maintain a more constant regard for that region. Other sensor rings that will also make a more even density are 1, 2 and 3 sensors, as well as 2, 3 and 5 sensors.

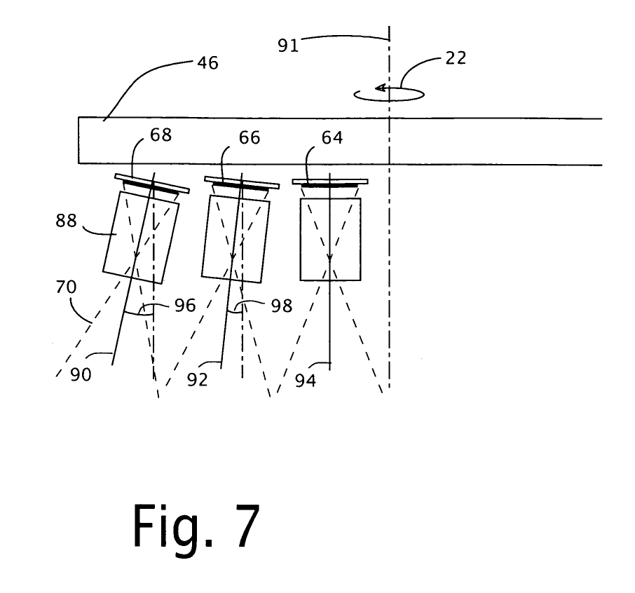

In another embodiment, as shown in FIG. 6., the scanning camera can be affixed to the top of a tall pole or tower, and viewing all or part of a surrounding area In this case, the pole or tower 72 represents the fixed point of support for the camera, and the pattern of the scanning is adjusted to how wide an area is of interest. A rotational drive system 74 rotates the rotational scan wheel 76 so that the line scan sensors 78 and 80, together with their associated lenses and respective optical axes 82 and 84, scan the surrounding area repeatedly. The transmission of the image and control signals to a remote control station 86 in this case can be through wires instead of a wireless link. In imaging from a tower at a lower altitude the optical axes 82 and 84 are likely to diverge from the central axis of rotation to form a wide or narrow overall cone. This contrasts with implementations in which the camera system is at a high altitude, where the optical axis of each line scan sensor may be more substantially parallel to the axis of rotation.

FIG. 7 is an cross section view of sensors at different of FIG. 5. Three line scan sensors are shown at 64, 66, and 68, to illustrate the sensors in the concentric rings 65, 67, and 69, respectively. Sensors 64, 66, and 68 have associated lens arrangements 88 with respective optical axes 94, 92, and 90. All of these elements are coupled to a rotational scan wheel 46, which is rotated 22 about a rotational axis 91. To get wider overall coverage, some of the line scan sensors may be turned outward from the axis of rotation As shown in the illustrated example, optical axes 90 and 92 form slight angles 96 and 98, respectively, relative to the central axis of rotation 92.

Various components are already available to aid in the construction of such a system. For better sensitivity to light in the line scan sensor, Time Delay Integration (TDI) scanners can be used. An example is the Fairchild Osprey CAM/CCD-4KLV.TDI high performance camera sensor. Schneider Optical's 12 k 5.6/120 Line Scan lenses can support resolutions of up to a 12K line scan. Sony's ILX585K line scan sensor has a resolution of up to 64K pixels. For data processing and transmission, Bitware's T2-PM Digital Signal Processing board has ADSP-TS201 Tiger Sharc processors with up to 6 GB/sec throughput, which is the equivalent of 7.5 800 MB scans per second. Video Perception, Inc. has special-purpose chips for motion detection and image extraction.

Discarding non-moving objects data reduces the overall data flow to manageable levels. For a further reduction, the identified moving objects can be represented as symbols, rather than as collections of pixels, thereby simplifying storage and transmission of essential information. Multiplying the scanning sensors and applying parallel data paths enables a faster repeating frame speed, which has a better change of catching an accurate picture of moving objects.

### OPERATIONS, RAMIFICATIONS AND SCOPE

It will be appreciated by one skilled in the art that the present invention can also be presented in other embodiments. It will be evident to artisans that features and details given above are exemplary only. Except where expressly indicated, it should be understood that none of the given details is essential; each is generally susceptible to variation, or omission.

1. A camera, comprising:
at least one line scan sensor; and
a rotational drive system to rotate the at least one line scan sensor about a rotational axis to obtain image data of an imaged area, the at least one line scan sensor having an optical axis that is not parallel to the rotational axis.

2. The camera of claim 1 in which the optical axis of the at least one line scan sensor is at an acute angle to the rotational axis.

3. The camera of claim 1 in which the optical axis of the at least one line scan sensor is parallel to the rotational axis.

4. The camera of claim 1 in which the at least one line scan sensor includes a first line scan sensor that senses light of a first wavelength range and a second line scan sensor that senses light of a second wavelength range that is different from the first wavelength range.

5. The camera of claim 4 in which the first and second line scan sensors are substantially parallel to each other.

6. The camera of claim 1 in which the at least one line scan sensor includes plural line scan sensors that are radially positioned relative to the rotational axis.

7. The camera of claim 6 in which the plural line scan sensors that are radially positioned relative to the rotational axis include a first number of line scan sensors at a first radial distance from the rotational axis and a second number of line scan sensors at a second radial distance from the rotational axis, the second radial distance being greater than the first radial distance.

8. A camera, comprising:
at least one line scan sensor;
a rotational drive system to rotate the at least one line scan sensor about a rotational axis to obtain raw image data of an imaged area, the at least one line scan sensor having an optical axis that is not parallel to the rotational axis; and
a processor that reduces the raw image data to motion image data corresponding to changes between successive frames.

9. The camera of claim 8 in which the optical axis of the at least one line scan sensor is at an acute angle to the rotational axis.

10. The camera of claim 8 in which the optical axis of the at least one line scan sensor is parallel to the rotational axis.

11. The camera of claim 8 in which the at least one line scan sensor includes a first line scan sensor that senses light of a first wavelength range and a second line scan sensor that senses light of a second wavelength range that is different from the first wavelength range.

12. The camera of claim 11 in which the first and second line scan sensors are substantially parallel to each other.

13. The camera of claim 8 in which the at least one line scan sensor includes plural line scan sensors radially positioned relative to the rotational axis.

14. The camera of claim 13 in which the plural line scan sensors radially positioned relative to the rotational axis include a first number of line scan sensors at a first radial distance from the rotational axis and a second number of line scan sensors at a second radial distance from the rotational axis, the second radial distance being greater than the first radial distance.

15. A camera, comprising:
plural line scan sensors; and
a rotational drive system to rotate the plural line scan sensors about a rotational axis to obtain image data of an imaged area, the plural line scan sensors each having an optical axis that is not parallel to the rotational axis.

16. The camera of claim 15 in which the optical axis of each of the plural line scan sensors is at an acute angle to the rotational axis.

17. The camera of claim 15 in which the optical axis of each of the plural line scan sensors is parallel to the rotational axis.

18. The camera of claim 15 in which the plural line scan sensors includes a first line scan sensor that senses light of a first wavelength range and a second line scan sensor that senses light of a second wavelength range that is different from the first wavelength range.

19. The camera of claim 15 in which the image data of the imaged area is raw image data and the camera further comprises a processor that reduces the raw image data to motion image data corresponding to changes between successive frames.
